(19) United States
(12) Patent Application Publication
(10) Pub. No.: US 2023/0191597 A1
(43) Pub. Date: Jun. 22, 2023

(54) CONTROL DEVICE, CONTROL METHOD, AND PROGRAM

(71) Applicant: SONY CORPORATION, Tokyo (JP)

(72) Inventors: Muneyuki HORIGUCHI, Kanagawa (JP); Hidenori KAMBAYASHI, Kanagawa (JP)

(73) Assignee: SONY CORPORATION, Tokyo (JP)

(21) Appl. No.: 16/959,850

(22) PCT Filed: Nov. 26, 2018
(86) PCT No.: PCT/JP2018/043383

§ 371 Date: Jul. 2, 2020

(30) Foreign Application Priority Data
Jan. 10, 2018 (JP) 2018-002003

(51) Int. Cl. B25J 9/16; B62D 57/032; B25J 13/08; G05B 19/4155; H02K 7/116

(52) U.S. Cl. CPC B25J 9/1633; B62D 57/032; B25J 13/088; G05B 19/4155; H02K 7/116; G05B 2219/39221

(57) ABSTRACT

There is provided a control device to protect an actuator through a simple configuration in a case where a power transmission mechanism receives external force, the control device including a comparison section and a driving force control section. The comparison section compares a first rotation position and a second rotation position with each other. The first rotation position is a rotation position of an input shaft of a power transmission mechanism, and the second rotation position is a rotation position of an output shaft of the power transmission mechanism. The driving force control section controls driving force of an actuator that drives the input shaft on the basis of a difference between the first rotation position and the second rotation position. This configuration allows the actuator to be protected through a simple configuration in a case where the power transmission mechanism receives external force.

### TECHNICAL FIELD

The present disclosure relates to a control device, a control method, and a program.

### BACKGROUND ART

PTL 1 listed below, for example, has disclosed a robotic device that includes a joint driving actuator and moves an arm or the like using the joint driving actuator.

### CITATION LIST

### Patent Literature

PTL 1: Japanese Unexamined Patent Application Publication No. 2010-188471

### SUMMARY OF THE INVENTION

### Problems to be Solved by the Invention

When external force such as impact is unavoidably applied to an arm, for example, of a robotic device as disclosed in PTL 1 listed above, the joint driving actuator or other members may be damaged in some cases. In order to prevent such damage due to impact or the like from side of a driving force output, some existing robotic devices have a mechanical power restricting mechanism such as that of slippage type or ratchet type. Even in a case where the arm, which is on the side of the driving force output, receives external force, providing the power restricting mechanism makes it possible to reduce damage to the actuator, which is on side of a driving force input, because of occurrence of mechanical slippage between driving force input side and driving force output side.

However, the above-described mechanical power restricting mechanism relies on a mechanical structure to implement its function and may therefore cause variation in the value of restricted power, making it difficult to precisely manage the value of restricted power, which becomes an issue. In addition, restricting the power may cause mechanical abrasion, leading to deterioration of a mechanism part, which becomes an issue.

Another issue is that mounting the mechanical power restricting mechanism in a robotic device results in an increase in the volume and the weight of a portion thereof where the drive restricting mechanism is mounted. Furthermore, it is difficult for the mechanical power restricting mechanism to dynamically change driving force upon operation in accordance with the environment. Still another issue is that the mechanical power restricting mechanism may cause backlash or mechanical and elastic deformation, leading to deterioration of linearity in power transmitting performance.

It has been therefore desired to protect an actuator through a simple configuration in a case where a power transmission mechanism receives external force.

### Means for Solving the Problems

According to the present disclosure, there is provided a control device including: a comparison section that compares a first rotation position and a second rotation position with each other, in which the first rotation position is a rotation position of an input shaft of a power transmission mechanism, and the second rotation position is a rotation position of an output shaft of the power transmission mechanism; and a driving force control section that controls driving force of an actuator that drives the input shaft on the basis of a difference between the first rotation position and the second rotation position.

In addition, according to the present disclosure, there is also provided a control method including comparing a first rotation position and a second rotation position with each other, in which the first rotation position is a rotation position of an input shaft of a power transmission mechanism, and the second rotation position is a rotation position of an output shaft of the power transmission mechanism; and controlling driving force of an actuator that drives the input shaft on a basis of a difference between the first rotation position and the second rotation position.

In addition, according to the present disclosure, there is also provided a program that causes a computer to execute as: a means for comparing a first rotation position and a second rotation position with each other, the first rotation position being a rotation position of an input shaft of a power transmission mechanism, the second rotation position being a rotation position of an output shaft of the power transmission mechanism; and a means for controlling driving force of an actuator that drives the input shaft on a basis of a difference between the first rotation position and the second rotation position.

### Effects of the Invention

As described above, according to the present disclosure, it is possible to protect the actuator through a simple configuration in a case where the power transmission mechanism receives external force.

It is to be noted that the above-mentioned effects are not necessarily limitative; in addition to or in place of the above effects, there may be achieved any of the effects described in the present specification or other effects that may be grasped from the present specification.

### BRIEF DESCRIPTION OF DRAWING

FIG. 1 is a schematic view of external appearance of a robotic device and rotational axes of joints.

FIG. 2 is an explanatory schematic view of a configuration of each of the joints.

FIG. 3 solely illustrates an actuator unit.

FIG. 4 is a schematic view of the actuator unit without an exterior cover.

FIG. 5 is a schematic exploded view of the actuator unit.

FIG. 6 is an explanatory schematic view of a situation in which a reduction mechanism and other mechanism components between rotation detectors are under load, causing slight deformation such as flexure.

FIG. 7 is an explanatory schematic view of a situation in which the reduction mechanism and other mechanism components between the rotation detectors are under load, causing slight deformation such as flexure.

FIG. 8 is a schematic view of a relationship between elapsed time and a difference between a position signal from a rotation detector on side of a motor and a position signal from a rotation detector on side of an output gear.

FIG. 9 is a schematic view of a relationship between elapsed time and a difference between a position signal from the rotation detector on the side of the motor and a position signal from the rotation detector on the side of the output gear.

FIG. 10 is a block diagram illustrating configurations of a control device and the actuator unit.

FIG. 11 is a flowchart illustrating a flow of a process to be performed by the control device.

FIG. 12 is a flowchart illustrating a flow of a process to be performed by the control device.

FIG. 13 is a flowchart illustrating a flow of a process to be performed by the control device.

### MODES FOR CARRYING OUT THE INVENTION

Hereinafter, description is given in detail of preferred embodiments of the present disclosure with reference to the accompanying drawings. It is to be noted that, in the present specification and drawings, repeated description is omitted for components substantially having the same functional configuration by assigning the same reference numerals.

It is to be noted that the description is given in the following order.

### 1. Configuration of Robotic Device

### 2. Configuration of Joint

### 3. Action of External Force on Movable Arm

### 4. Configuration to Restrict Action of External Force on Motor

4.1. Control based on Phase Difference between Motor Rotation Detector and Output Gear Rotation Detector

4.2. Control based on Value of Current Flowing through Motor

5. Configuration of Control Device according to Present Embodiment
6. Flow of Process by Control Device according to Present Embodiment
7. Cooperation with Higher-level Controller
8. Cooperation with External Server

### 1. Configuration of Robotic Device

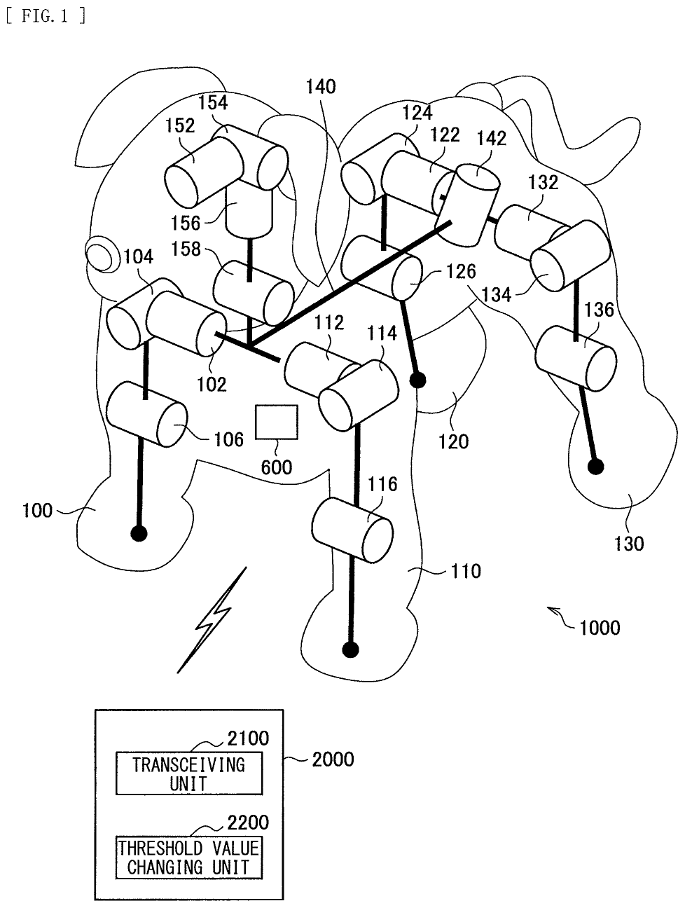

FIG. 1 is a schematic view of external appearance of a robotic device 1000 and rotational axes of joints. The robotic device 1000 includes four legs 100, 110, 120, and 130 to be driven by electric motors such as servomotors.

As illustrated in FIG. 1, the robotic device 1000 includes a plurality of joints. For convenience of explanation, the robotic device 1000 herein is divided into the following systems according to movement thereof: a right front leg system, a left front leg system, a right hind leg system, a left hind leg system, a body (Body) system, and a head system. The right front leg system has a joint 102, a joint 104, and a joint 106. The left front leg system has a joint 112, a joint 114, and a joint 116. The right hind leg system has a joint 122, a joint 124, and a joint 126. The left hind leg system has a joint 132, a joint 134, and a joint 136. In addition, the body system has a joint 142. The head system has a joint 152, a joint 154, a joint 156, and a joint 158. Each of the systems is coupled to a torso 140. It is to be noted that each of the joints illustrated in FIG. 1 represents a principle joint to be driven by an electric motor. In addition to the joints illustrated in FIG. 1, the robotic device 1000 has joints that passively move in accordance with movement of other joints. In addition, the robotic device 1000 further has a plurality of movable parts such as a mouth, ears, and a tail, which are also driven by electric motors or the like.

Each of the joints is depicted as a circular cylinder in FIG. 1. In each of the joints, a central axis of the circular cylinder corresponds to a rotational axis of the joint.

Each of the joints is driven by an electric motor (referred to below simply as a motor) such as a servomotor. It is to be noted that no particular limitations are placed on the drive source. The motor of each of the joints is contained in a single box (box) together with a gear mechanism and a microcontroller for driving the motor. The box includes a resin material (plastic). It is possible to enhance silence of the robotic device 1000 by including the motor and the gear mechanism in the single box and sealing the box.

The box for containing the motor, the gear mechanism, and the microcontroller may be a two-axis box or a single-axis box. In the case of the right hind leg system, for example, the motors, the gear mechanisms, and the microcontrollers of the joints 132 and 134 are contained in a single box 200, and the box 200 constitutes two rotational axes. Meanwhile, the motor, the gear mechanism, and the microcontroller of the joint 136 are contained in a single box 210, and the box 210 constitutes a single rotational axis.

According to the present embodiment, in particular, containing the two rotational axes in the single box 200 makes it possible to achieve a spherical joint. Furthermore, containing the two rotational axes in the single box makes it possible to reduce space related to the joints, allowing the shape of the robotic device 1000 to be determined while putting more importance on design.

Each of the above-described systems such as the right front leg system is controlled by the microcontroller (a control device 500 described below) of each of the joints. Among the joints, the joint 158 in the head system, for example, is configured to be electronically braked. When the joint 158 is freely rotatable during a power-off state, the head descends, and may possibly hit a user's hand, for example. Braking for the joint 158 enables such a situation to be avoided. It is possible to achieve the braking by determining the rotation of the motor of the joint 158 and generating driving force in a direction opposite to a rotating direction of the motor on the basis of electromotive force generated by the rotation of the motor during the power-off state.

### 2. Configuration of Joint

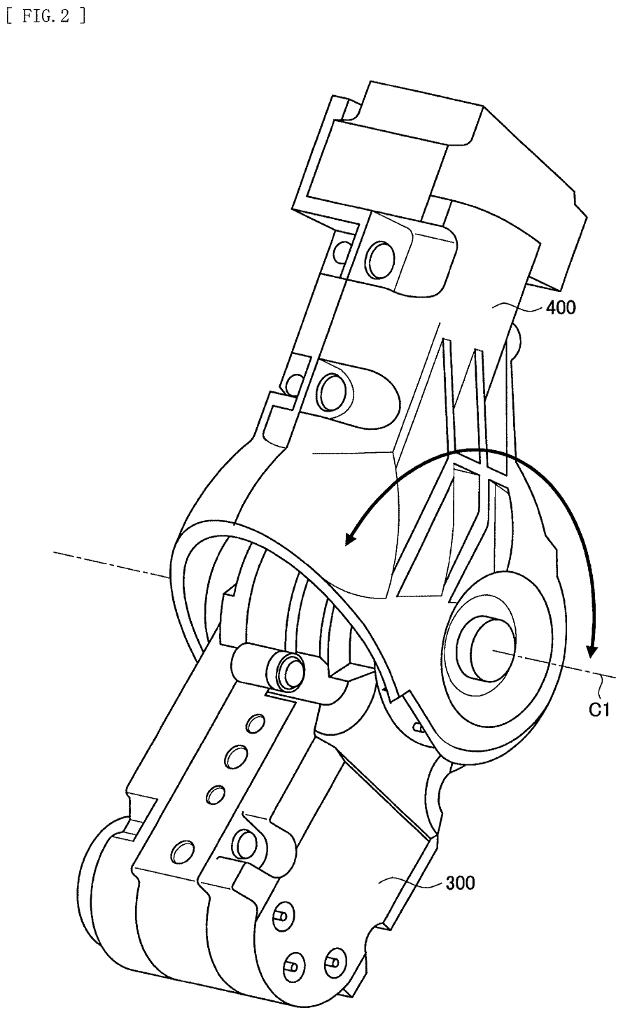

FIG. 2 is an explanatory schematic view of a configuration of each of the joints. For convenience of explanation, the configuration of each of the joints is described by way of example of a joint with a single rotational axis. The joint includes an actuator unit 300 and a movable arm 400. The actuator unit 300 illustrated in FIG. 2 corresponds to the above-described box. The driving force of a motor 314 of the actuator unit 300 causes the movable arm 400 to rotate relative to the actuator unit 300 about a rotational axis, which is depicted as a dashed and dotted line C1 in FIG. 2. This achieves the joint with the single rotational axis.

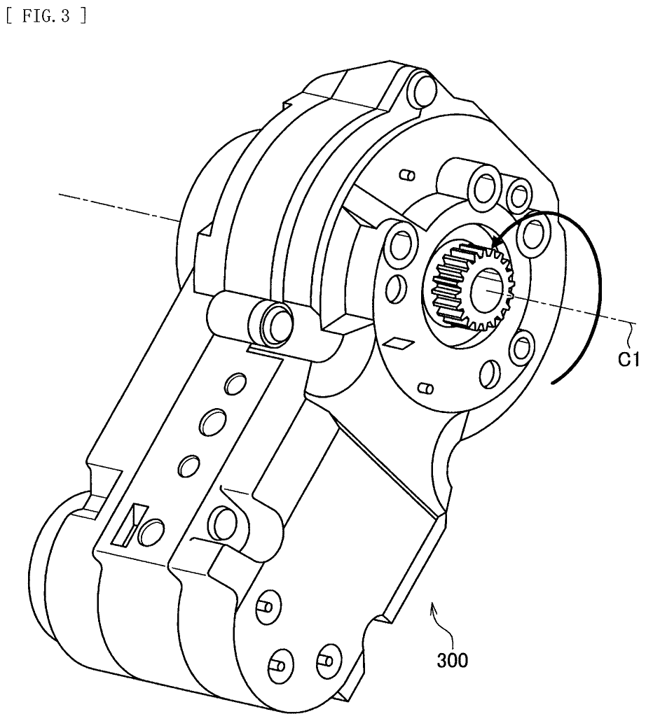

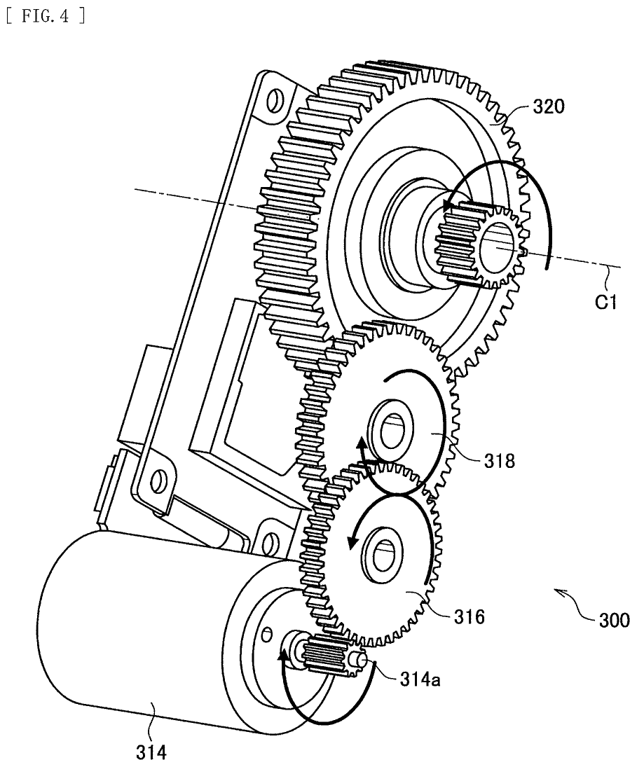

FIG. 3 solely illustrates the actuator unit 300. Furthermore, FIG. 4 is a schematic view of the actuator unit 300 without an exterior cover. Furthermore, FIG. 5 is a schematic exploded view of the actuator unit 300.

As illustrated in FIGS. 4 and 5, the actuator unit 300 includes a rear cover 302, a control board 304, a gearbox base 306, a bearing 308, a gearbox cover 310, a detection magnet 312, the motor (actuator) 314, a first gear 316, a second gear 318, an output gear 320, a rotation detector 322 for the motor 314, and a rotation detector 324 for the output gear 320.

In the configuration illustrated in FIGS. 4 and 5, the driving force of the motor 314 is transmitted to the output gear 320 via the first gear 316 and the second gear 318. A rotational shaft of the output gear 320 coincides with the rotational axis C1 and is fixed to the movable arm 400. Thus, the driving force of the motor 314 causes the movable arm 400 to rotate about the rotational axis C1. It is to be noted that the bearing 308 rotatably supports the output gear 320.

The rotation detector 322 for the motor 314, for example, includes a Hall element or the like, and detects an absolute rotation position of a rotational shaft of the motor 314. The rotation detector 324 for the output gear 320 is provided on the control board 304. The detection magnet 312 has a ring shape, and is fixed to the output gear 320 and rotates together with the output gear 320. An outer periphery of the detection magnet 312 is provided with a specific magnetizing pattern. The rotation detector 324 for the output gear 320 includes, for example, an MR sensor or the like, and detects an absolute rotation position of the detection magnet 312, i.e., an absolute rotation position of the output gear 320. Furthermore, the control device 500 that controls the motor 314 is provided on the control board 304.

### 3. Action of External Force on Movable Arm

The driving force of the motor 314 causes the movable arm 400 to rotate relative to the actuator unit 300. In addition, the driving force of the motor 314 also keeps the movable arm 400 at a certain angular position relative to the actuator unit 300. Through this principle, each of the joints in the above-described systems such as the right front leg system operates or is kept at a fixed angle.

Meanwhile, application of external force to the movable arm 400 while the joint is operating or while the joint is kept at a certain angle, for example, under the driving force of the motor 314 may be a cause of a failure. When impact at or above a certain level is applied to the movable arm 400, in particular, the motor 314 may be possibly damaged. Application of such external force may possibly occur, for example, by a person acting on the robotic device 1000 or by the robotic device 1000 itself making a movement (e.g., a movement of striking a wall or a movement of falling from a step).

### 4. Configuration to Restrict Action of External Force on Motor

### 4.1. Control Based on Phase Difference Between Motor Rotation Detector and Output Gear Rotation Detector

For the preparation of the external force acting on the movable arm 400 as described above, in the present embodiment, a control is performed to determine whether or not external force has been applied to the movable arm 400 on the basis of a phase difference between the absolute rotation position detected by the rotation detector 322 for the motor 314 and the absolute rotation position detected by the rotation detector 324 for the output gear 320, and to cut off the driving force of the motor 314 in a case where external force has been applied.

As described above, components such as a reduction mechanism (the first gear 316, the second gear 318, and the output gear 320) that transmits power are provided between the rotation detector 322 for the motor 314 and the rotation detector 324 for the output gear 320. As a result of external force or impact being applied to the output gear 320, which is on side of power output, the reduction mechanism and other mechanism components between the rotation detector 322 and the rotation detector 324 are loaded, causing slight deformation such as flexure.

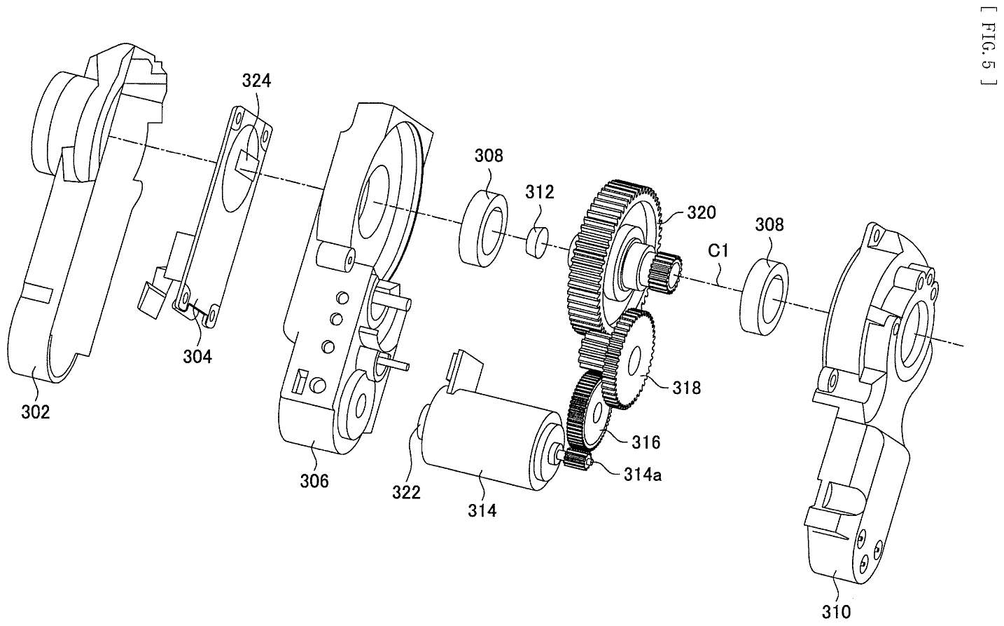

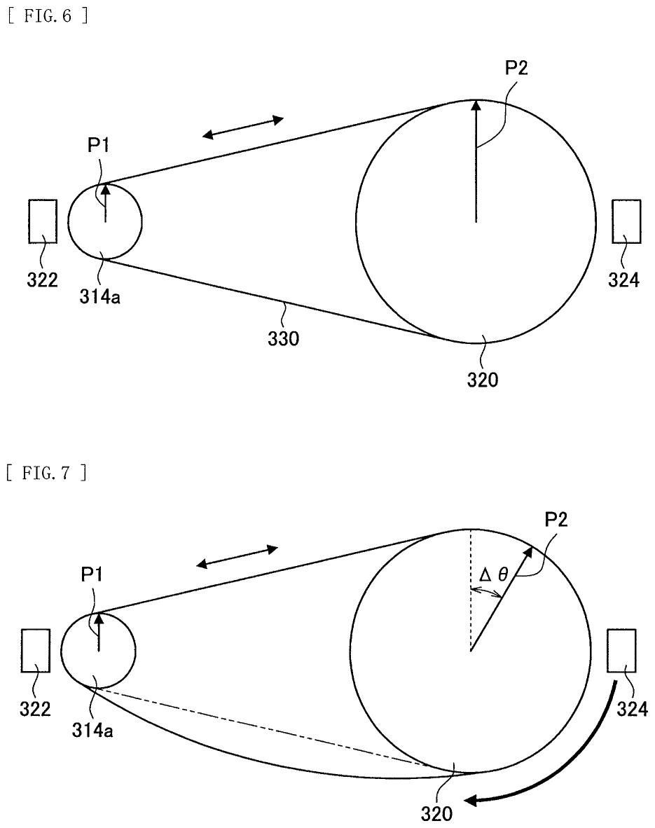

FIGS. 6 and 7 are each an explanatory schematic view of a situation where the reduction mechanism and other mechanism components between the rotation detector 322 and the rotation detector 324 are loaded, causing the slight deformation such as flexure. In order to facilitate explanation, FIGS. 6 and 7 schematically illustrate a rotational shaft 314a of the motor 314 and the output gear 320 coupled to each other by a belt 330.

FIG. 6 illustrates a situation in which no external force or impact is acting on the output gear 320, and the reduction mechanism and other mechanism components between the rotation detector 322 and the rotation detector 324 are not under load. Furthermore, FIG. 7 illustrates a situation in which external force or impact is acting on the output gear 320, and the reduction mechanism and other mechanism components between the rotation detector 322 and the rotation detector 324 are under load, causing slight deformation such as flexure.

Once external force or impact acts on the output gear 320, and the components between the rotation detector 322 and the rotation detector 324 are loaded, as illustrated in FIG. 7, one part of the belt 330 stretches due to the external force or impact, and the other part of the belt 330 is loosened. The stretching and loosening of the belt 330 correspond to slight deformation such as flexure that occurs in the reduction mechanism or other mechanism components between the rotation detector 322 and the rotation detector 324.

Such slight deformation results in a difference between a position signal from the rotation detector 322 for the motor 314 and a position signal from the rotation detector 324 for the output gear 320. Specifically, a rotation position P1 of the rotational shaft 314a of the motor 314 obtained from the rotation detector 322 coincides with a rotation position P2 of the output gear 320 obtained from the rotation detector 324 in FIG. 6, but there is a difference Δθ between the rotation position P1 and the rotation position P2 in FIG. 7. According to the present embodiment, this difference is calculated by a computing element, and output of the motor 314 is changed when the difference exceeds a predetermined threshold value, thereby preventing the motor 314 from being damaged. Thus, the motor 314 is protected.

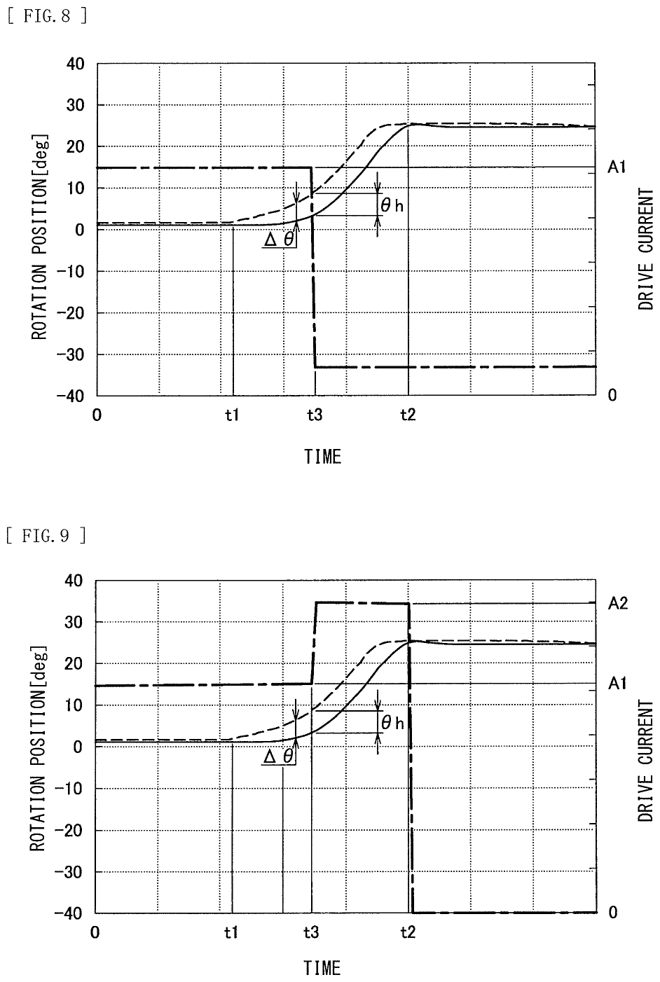

FIGS. 8 and 9 are each a schematic view of a relationship between elapsed time and a difference between a position signal from the rotation detector 322 for the motor 314 and a position signal from the rotation detector 324 for the output gear 320. FIGS. 8 and 9 illustrate changes with time in the rotation position (solid line) of the rotational shaft 314a of the motor 314 obtained from the rotation detector 322 and in the rotation position (dashed line) of the output gear 320 obtained from the rotation detector 324. In addition, FIGS. 8 and 9 also illustrate drive currents (dashed and dotted line) in the motor 314 that are varied depending on the difference between the rotation position (solid line) of the rotational shaft 314a of the motor 314 and the rotation position (dashed line) of the output gear 320.

As illustrated in FIGS. 8 and 9, the rotation position (solid line) of the rotational shaft 314a of the motor 314 obtained from the rotation detector 322 and the rotation position (dashed line) of the output gear 320 obtained from the rotation detector 324 coincide with each other until a time t1. After the time t1, there is a difference between the rotation position of the rotational shaft 314a of the motor 314 obtained from the rotation detector 322 and the rotation position of the output gear 320 obtained from the rotation detector 324 This results in a situation where the rotation position of the output gear 320 obtained from the rotation detector 324 has a larger degree than the rotation position of the rotational shaft 314a of the motor 314 obtained from the rotation detector 322. That is, it is appreciated that, at a time point of the time t1, external force, impact, or the like is applied to side of the output gear 320, and the rotation position difference Δθ described with reference to FIG. 7 starts to generate.

After the time t1, as illustrated in FIGS. 8 and 9, the rotation position difference Δθ increases with time, starts to decrease, and then returns to zero at a time t2. It is appreciated therefore that the external force, impact, or the like has been applied between the time t1 and the time t2.

FIGS. 8 and 9 provide two different examples of the drive current in the motor 314 controlled upon detection of the rotation position difference Δθ. In FIGS. 8 and 9, a predetermined drive current A1 keeps flowing through the motor 314, and the movable arm 400 keeps rotating in a predetermined direction or the movable arm 400 is kept in a predetermined fixed position until a time t3 when the rotation position difference Δθ reaches a predetermined threshold value Gth.

FIG. 8 illustrates an example in which the drive current in the motor 314 is decreased or cut off once the rotation position difference Δθ reaches the predetermined threshold value Δth (time t3). Such control performed upon application of external force or impact to the movable arm 400 reduces opposing force of the movable arm 400 against the external force or impact, thus suppressing application of excessive force to the motor 314. In particular, in a case where the drive current is cut off, the movable arm 400 is able to freely rotate in accordance with the external force or impact. This makes it possible to suppresses damage to the motor 314 due to external force or impact.

Here, the robotic device 1000 has different operation modes: “a relaxing (resting) mode in which electricity to the robotic device 1000 is off” and “a relaxing (resting) mode in which supply of electricity to the motor 314 is suspended”. Transition between these modes is achieved by cutting off the drive current in the motor 314 upon reception of external force or impact. It is to be noted that the term “relaxing” and the term “resting” herein have the same meaning.

Furthermore, during the “relaxing (resting) mode in which supply of electricity to the motor 314 is suspended”, control blocks other than the motor 314 having receiving the external force or impact are operable. Upon transition to this mode, LEDs or the like of “eyes” of the robotic device 1000 start showing a “beaten” or “troubled” feeling, and contents of the error are notified to an application in a user's smartphone or a cloud service (a server 2000).

The above-described operation of the robotic device 1000 enables the user to see as if the robotic device 1000 is unwilling to receive the external force or impact and avoids the external force or impact. In a case where external force is applied to a neck to restrict the driving force to the motor 314 of the joint of the neck, for example, the motors 314 of the joints of the legs other than the neck are driven, thereby performing a stumbling operation or a crouching operation. By making transition to a “stumbling mode” or a “crouching mode” in this manner upon application of external force or impact as a variation of the condition in terminating the control of the motor 314 at a timing when the power is cut off, it is possible for the user to see as if the robotic device 1000 is unwilling to receive the external force or impact and avoids the external force or impact.

In addition, FIG. 9 illustrates another example in which the motor 314 is controlled to cause the movable arm 400 to rotate in a direction of external force or impact by increasing the drive current in the motor 314 to A2 at a time point (time t3) when the rotation position difference Δθ reaches the predetermined threshold value θth. Such control performed upon application of external force or impact to the movable arm 400 allows the movable arm 400 to rotate in the direction in which the external force or impact is received, thus suppressing application of excessive force to the motor 314. Thereafter, the drive current in the motor 314 is cut off at the time t2 when the difference Δθ becomes zero. This makes it possible to suppress damage to the motor 314 due to external force or impact.

The control illustrated in FIG. 8 and the control illustrated in FIG. 9 may, for example, be switched according to magnitude of the rotation position difference Δθ, which is described below.

### 4.2. Control Based on Value of Current Flowing Through Motor

According to the present embodiment, control based on the value of the current flowing through the motor 314 is performed in addition to the above-described control based on the difference between the rotation position of the motor 314 and the rotation position of the output gear 320. In this case, a current detection sensor 340 that detects the current flowing through the motor 314 is provided, and a value measured thereby is used to enable flexible protection of the motor 314.

In order to cause the movable arm 400 to rotate or in order to keep the movable arm 400 in a predetermined angular position, a current flows through the motor 314. External force or impact causing forced rotation of the movable arm 400, if any, is transmitted to the motor 314 via the output gear 320, the second gear 318, and the first gear 316. This causes the motor 314 to rotate in a direction reverse to an original rotation direction.

Such reverse rotation of the motor 314 generates back-EMF voltage to increase the value of the current flowing through the motor 314. It is possible to prevent damage to the motor 314 due to external force to protect the motor 314 by constantly measuring and monitoring the current flowing through the motor 314 using the current detection sensor 340 and cutting off the driving force of the motor 314 upon detection of an increase in the current due to external force. As a specific method, the value of the current flowing through the motor 314 is measured, and the integral thereof is calculated; in a case where the integral over a specific period of time is greater than a predetermined threshold value, the current flowing through the motor 314 is cut off. Alternatively, the current flowing through the motor 314 may be controlled to be decreased in a case where the integral over the specific period of time exceeds the predetermined threshold value.

Furthermore, a temperature sensor may be provided to detect the temperature of the motor 314, because the temperature of the motor 314 increases due to the generation of back-EMF voltage; in a case where the temperature of the motor 314 exceeds a predetermined threshold value, the current flowing through the motor 314 may be decreased or cut off.

Determination on whether to perform the control based on the phase difference between the rotation positions or the control based on an integrated value of the current may be made depending on the positions of the joints of the robotic device 1000. As an example, the control based on the phase difference between the rotation positions is performed on the motors 314 of the joints susceptible to external force among the joints in the head and the torso, thus making it easier to invoke the restriction of the driving force to the motors 314 Examples of such motors 314 include the motors 314 of the joints 152, 154, 156, and 158 that perform a sideway head shaking movement, a nodding movement, a head tilting movement, a mouth movement, and a head lifting and lowering movement. The control based on the integrated value of the current is performed on the motors 314 of the other joints, thus making it relatively difficult to invoke the restriction of the driving force to such motors 314. Examples of the other joints include joints that perform an ear movement, a tail movement, a waist movement, a shoulder rotating movement, a shoulder spreading movement, and a knee movement. As described above, determination on whether to perform the control based on the phase difference between the rotation positions or the control based on the integrated value of the current may be made in consideration of magnitude and location of external force or impact to be applied. Meanwhile, it is possible, as a matter of course, to concurrently perform both the control based on the phase difference between the rotation positions and the control based on the integrated value of the current on any one of the motors 314.

### 5. Configuration of Control Device According to Present Embodiment

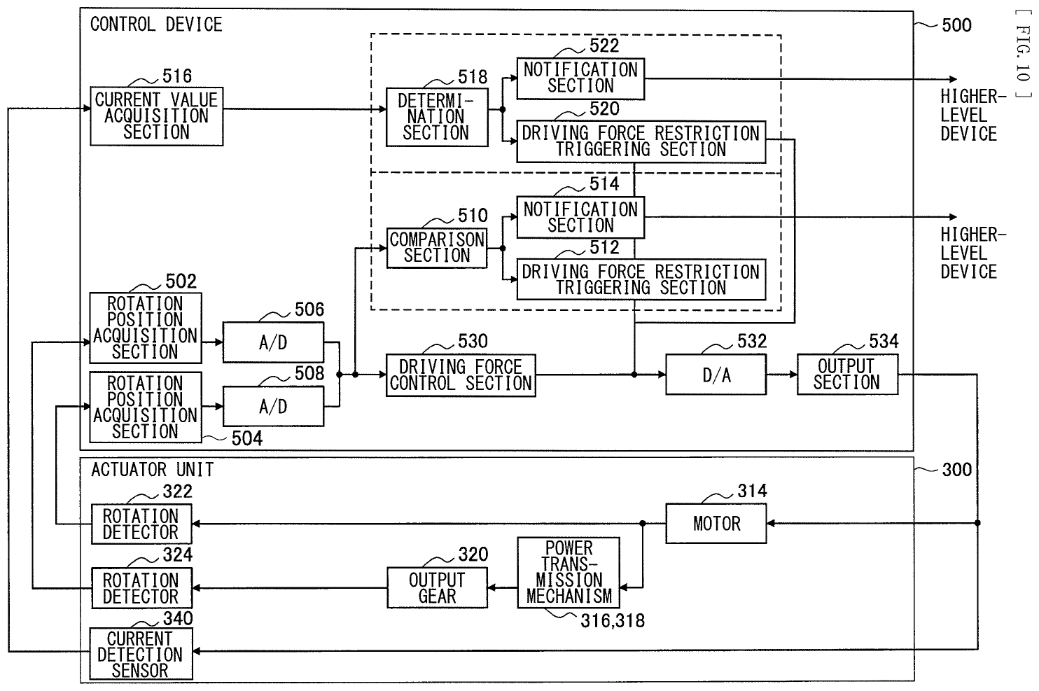

FIG. 10 is a block diagram illustrating configurations of the control device 500 that performs the above-described control and the actuator unit 300. The control device 500 includes a rotation position acquisition section 502 on side of an input where rotation position information of the motor 314 detected by the rotation detector 322 is inputted, a rotation position acquisition section 504 on side of output where rotation position information of the output gear 320 detected by the rotation detector 324 is inputted, an A/D converter 506 that performs A/D conversion of the rotation position information of the motor 314, and an A/D converter 508 that performs A/D conversion of the rotation position information of the output gear 320.

In addition, the control device 500 also includes a comparison section 510 that compares the rotation position information of the motor 314 and the rotation position information of the output gear 320 with each other and determines whether or not the difference Δθ therebetween exceeds the predetermined threshold value, a driving force restriction triggering section 512 that triggers the restriction of the driving force of the motor 314 on the basis of a result of the comparison performed by the comparison section 510, and a notification section 514 that notifies a higher-level device of the result of the comparison performed by the comparison section 510.

In addition, the control device 500 also includes a current value acquisition section 516 that acquires the value of the current flowing through the motor 314 detected by the current detection sensor 340, a determination section 518 that determines whether or not the integrated value of the current flowing through the motor 314 exceeds the predetermined threshold value, a driving force restriction triggering section 520 that triggers the restriction of the driving force of the motor 314 in a case where the integrated value of the current flowing through the motor 314 exceeds the predetermined threshold value, and a notification section 522 that notifies a higher-level device that the integrated value of the current flowing through the motor 314 exceeds the predetermined threshold value.

In addition, the control device 500 further includes a driving force control section 530 that controls the driving force of the motor 314 by controlling the current flowing through the motor 314 in a case where the driving force restriction triggering section 512 or the driving force restriction triggering section 520 has triggered the restriction of the driving force of the motor 314, a D/A converter 532 that performs D/A conversion of an instruction to control the current flowing through the motor 314 from the driving force control section 530, and an output section 534 that outputs, to the motor 314 of the actuator unit 300, the D/A converted instruction to control the current flowing through the motor 314. It is to be noted that each of the constituent elements of the control device 500 may be implemented by a circuit (hardware) or by a central processing unit such as CPU and a program (software) for operation of the central processing unit.

### 6. Flow of Process by Control Device According to Present Embodiment

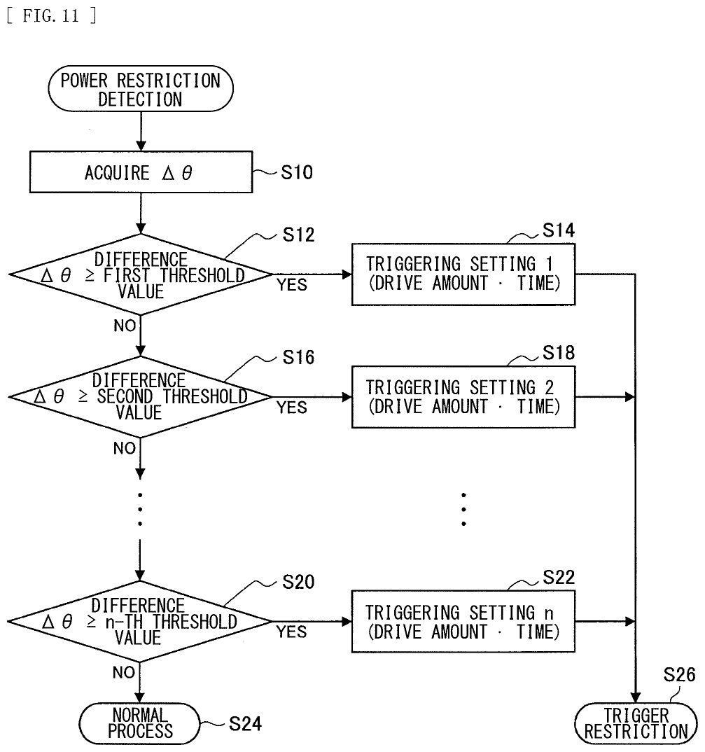

FIGS. 11 to 13 are each a flowchart illustrating a flow of a process to be performed by the control device 500. FIG. 11 illustrates the control based on the difference Δθ described with reference to FIGS. 8 and 9. First, at step S10, the comparison section 510 acquires the difference Δθ between the rotation position of the motor 314 and the rotation position of the output gear 320. Next, at step S12, the comparison section 510 determines whether or not the difference Δθ is greater than or equal to a first threshold value. Ina case where the difference Δθ is greater than or equal to the first threshold value, the process advances to step S14. At step S14, as described with reference to FIG. 9, the value of the current flowing through the motor 314 is controlled to allow the motor 314 to rotate in the direction of external force or impact, and then a setting for triggering the control to cut off the current (triggering setting 1) is made.

In addition, in a case where the difference Δθ is less than the first threshold value at step S12, the process advances to step S16. At step S16, it is determined whether or not the difference Δθ is greater than or equal to a second threshold value, and the process advances to step S18 in a case where the difference Δθ is greater than or equal to the second threshold value. At step S18, as described with reference to FIG. 8, a setting for triggering the control to decrease the value of the current flowing through the motor 314 or cut off the current (triggering setting 2) is made. It is to be noted that the second threshold value is smaller than the first threshold value, and thus the control illustrated in FIG. 9 is performed in the case of a larger difference Δθ. Thus, in the case of application of greater external force or impact to the movable arm 400, the motor 314 is controlled to allow the movable arm 400 to rotate in the direction of the external force or impact. It is therefore possible to reliably reduce damage to the motor 314.

In a case where the difference Δθ is less than the second threshold value at step S16, a similar process based on the threshold value is repeated, and a setting for triggering the control of the motor 314 according to the magnitude of the difference Δθ is made. At step S20, it is determined whether or not the difference Δθ is greater than or equal to an n-th threshold value. In a case where the difference Δθ is greater than or equal to the n-th threshold value, the process advances to step S22, and a setting for triggering the control of the motor 314 according to the magnitude of the difference Δθ (triggering setting n) is made. The n-th threshold value is smaller than a (n−1)-th threshold value. In a case where the difference Δθ is less than the n-th threshold value at step S22, a normal process is performed, assuming that no external force or impact is applied to the movable arm 400.

After the setting for triggering the control of the motor 314 has been made at step S14, S16, or S22, at step S26, the driving force restriction triggering section 512 triggers the control to restrict the driving force of the motor 314 on the basis of the triggering setting 1, 2, or n, and the driving force control section 530 executes the control of the motor 314. This causes the motor 314 to be controlled in accordance with external force or impact, thus suppressing damage to the motor 314.

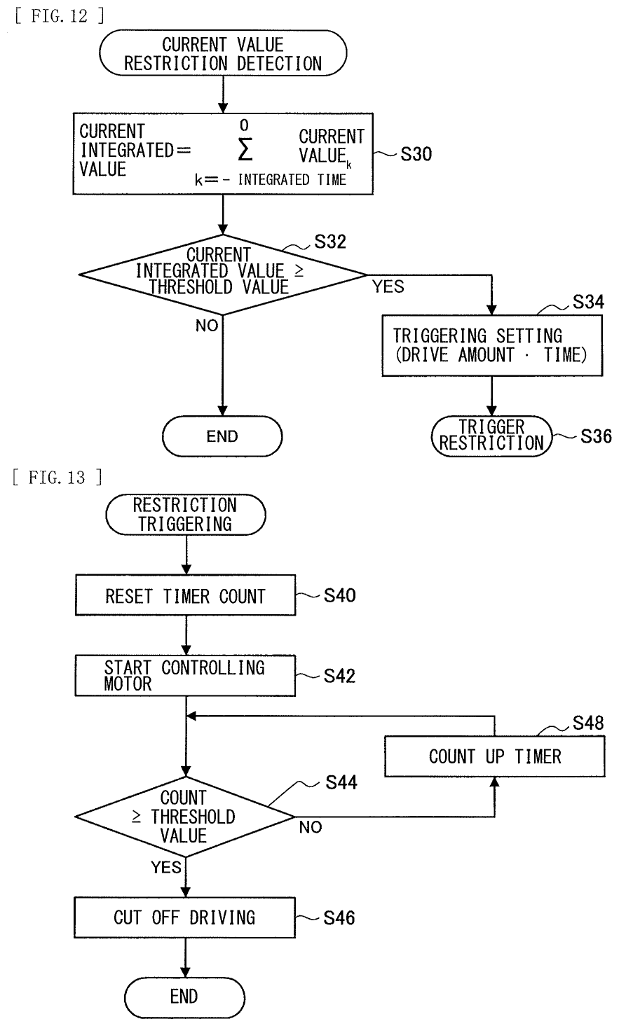

Furthermore, FIG. 12 is a flowchart illustrating the flow of the control of the motor 314 based on the integrated value of the current flowing through the motor 314. First, at step S30, integration of the current flowing through the motor is performed over a predetermined integrated time. Next, at step S32, the determination section 518 determines whether or not the integrated value obtained through the integration at step S30 is greater than or equal to the predetermined threshold value. In a case where the integrated value is greater than or equal to the predetermined threshold value, the process advances to step S34. At step S34, a setting for triggering the control to restrict the current flowing through the motor 314 is made. Next, at step S36, the driving force restriction triggering section 520 triggers the control to restrict the driving force of the motor 314, and the driving force control section 530 executes the control of the motor 314. This causes the control of the motor 314 to be controlled in accordance with external force or impact, thus suppressing damage to the motor 314. In addition, in a case where the integrated value is less than the predetermined threshold value at step S32, the process ends (END).

FIG. 13 is a flowchart illustrating a process of eventually cutting off the driving force of the motor 314 when a predetermined period of time has elapsed after the start of the control of the motor 314 corresponding to external force or impact. First, at step S40, the count in a timer is reset. Next, at step S42, the control of the motor 314 corresponding to external force or impact is started. Next, at step S44, it is determined whether or not a count value in the timer is greater than or equal to a predetermine threshold value. In a case where the count value is greater than or equal to the predetermined threshold value, the process advances to step S46, and the driving of the motor 314 is cut off. Meanwhile, in a case where the count value in the timer is less than the predetermined threshold value at step 44, the count value in the timer is counted up at step S48, and then the processes after step S44 is continued to be performed.

7. Cooperation with Higher-Level Controller

As described above, the control device 500 includes the notification section 514 that notifies a higher-level device of the result of the comparison performed by the comparison section 510, and the notification section 522 that notifies a higher-level device that the integrated value of the current flowing through the motor 314 exceeds the predetermined threshold value. Receiving these notifications, a higher-level control device 600 of the robotic device 1000 recognizes that the driving force of the motor 314 is restricted by the control device 500. It is therefore possible for the higher-level control device 600 to shut down the entire robotic device 1000 or cause the robotic device 1000 to make a movement for notifying the user of abnormality after receiving the notifications. It is also possible for the higher-level control device 600 to cause the robotic device 1000 to perform a notification or a display for notifying the user of the abnormality.

In addition, in the above-described example, the control device 500 included in the individual actuator unit 300 performs the calculation for the restriction of the power of the motor 314. Alternatively, however, the rotation position information and the current value information may be transmitted to the higher-level control device 600, and the calculation may be performed by the control device 600.

In a case where the control device 500 included in the actuator unit 300 performs the calculation for the restriction of the power of the motor 314, the amount of communication data to be exchanged in the communication with the control device 600 and the time of the communication are able to be saved, thus enabling highly precise calculation. Meanwhile, in a case where the calculation is performed by the higher-level control device 600, the control device 600 is able to monitor a plurality of motors 314 of the respective joints, thus making it possible to continue an overall movement of the robotic device 1000 by optimally control a subsequent motion thereof at the time of triggering the driving force restriction. For example, a case is assumed where, when the driving force of the motors 314 of the joints in the right leg systems is cut off, the driving force of the motors 314 of the joints of the other legs is increased, thereby making it possible to maintain a walking ability of the robotic device 1000.

8. Cooperation with External Server

As illustrated in FIG. 1, the robotic device 1000 is configured to able to communicate with the external server 2000. The communication may be wireless or wired. Furthermore, no particular limitations are placed on the communication method, and any method may be employed.

The communication of the robotic device 1000 with the external server 2000 also makes it possible to optimally change a threshold value θh for triggering the above-described driving force restriction. For example, in a case where the driving force restriction due to external force, impact, or the like occurs frequently with the threshold value θh set at a default value, the robotic device 1000 may make transmission to that effect to the server 2000, and side of the server 2000 may change the threshold value θh. In this case, a threshold value changing unit 2200 of the server 2000 changes the threshold value θh, and a transceiving unit 2100 thereof transmits the changed threshold value θh to the robotic device 1000.

Side of the robotic device 1000 receives the changed threshold value θh, and changes a setting of the threshold value θh in the control device 500 or the control device 600. This enables a uniform change in the threshold value θh among a plurality of robotic devices 1000 and optimal adaptation of the threshold value θh according to circumstances of occurrence of the driving force restriction.

According to the present embodiment described above, it is possible to detect excessive load on the motor 314 and restrict the driving force thereof, thus preventing damage to the motor 314 due to external force and achieving high reliability. Furthermore, no mechanical mechanism needs to be provided, thus enabling reduction in size and weight. Furthermore, in configuration for restricting the driving force of the motor 314, mechanical failure and deterioration do not occur, thus achieving longer life of the configuration for restricting the driving force.

Furthermore, unlike a mechanical mechanism, according to the present embodiment, it is possible to vary transmission of external force to the motor 314 by changing the threshold value of the difference Δθ or the threshold value of the integrated value of the current. It is therefore possible to achieve a wide range of protecting function against different inputs such as external force that carries less load but lasts long or impact that does not last long but carries greater load by changing the restriction of the driving force of the motor 314.

Although the description has been given above in detail of preferred embodiments of the present disclosure with reference to the accompanying drawings, the technical scope of the present disclosure is not limited to such examples. It is obvious that a person having ordinary skill in the art of the present disclosure may find various alterations or modifications within the scope of the technical idea described in the claims, and it should be understood that these alterations and modifications naturally come under the technical scope of the present disclosure.

In addition, the effects described herein are merely illustrative or exemplary, and are not limitative. That is, the technology according to the present disclosure may achieve, in addition to or in place of the above effects, other effects that are obvious to those skilled in the art from the description of the present specification.

It is to be noted that the technical scope of the present disclosure also includes the following configurations.

(1)

A control device including:

a comparison section that compares a first rotation position and a second rotation position with each other, the first rotation position being a rotation position of an input shaft of a power transmission mechanism, the second rotation position being a rotation position of an output shaft of the power transmission mechanism; and

a driving force control section that controls driving force of an actuator that drives the input shaft on a basis of a difference between the first rotation position and the second rotation position.

(2)

The control device according to (1), in which the driving force control section controls the driving force of the actuator on a basis of the difference in a case where external force is applied to the output shaft.

(3)

The control device according to (1) or (2), in which the driving force control section restricts the driving force of the actuator in a case where the difference reaches a predetermined threshold value.

(4)

The control device according to any one of (1) to (3), in which the driving force control section lowers a drive current in the actuator in the case where the difference reaches the predetermined threshold value.

(5)

The control device according to (4), in which the driving force control section lowers the drive current in the actuator to zero in the case where the difference reaches the predetermined threshold value.

(6)

The control device according to (2), in which the driving force control section controls the actuator to drive the actuator in a direction in which the external force is received in a case where the difference reaches a predetermined threshold value.

(7)

The control device according to (6), in which the driving force control section increases a drive current in the actuator to drive the actuator in the direction in which the external force is received in the case where the difference reaches the predetermined threshold value.

(8)

The control device according to (7), in which the driving force control section increases the drive current in the actuator, and then decreases the drive current in the actuator in accordance with a decrease in the difference.

(9)

The control device according to any one of (1) to (8), including a determination section that determines an integrated value of a current flowing through the actuator, in which

the driving force control section restricts the driving force of the actuator when the integrated value reaches a predetermined value.

(10)

The control device according to any one of (1) to (9), in which

the actuator is provided with a first rotation detector that acquires the first rotation position, and

the output shaft of the power transmission mechanism is provided with a second rotation detector that acquires the second rotation position.

(11)

The control device according to any one of (1) to (10), in which

the control device is included in a robotic device that walks autonomously, and

the driving force control section controls the driving force of the actuator included in the robotic device.

(12)

A control method including:

comparing a first rotation position and a second rotation position with each other, the first rotation position being a rotation position of an input shaft of a power transmission mechanism, the second rotation position being a rotation position of an output shaft of the power transmission mechanism; and

controlling driving force of an actuator that drives the input shaft on a basis of a difference between the first rotation position and the second rotation position.

(13)

A program that causes a computer to function as:

a means for comparing a first rotation position and a second rotation position with each other, the first rotation position being a rotation position of an input shaft of a power transmission mechanism, the second rotation position being a rotation position of an output shaft of the power transmission mechanism; and

a means for controlling driving force of an actuator that drives the input shaft on a basis of a difference between the first rotation position and the second rotation position.

### REFERENCE NUMERALS LIST

314 motor
322, 324 rotation detector
500 control device
510 comparison section
518 determination section
530 driving force restriction section

1. A control device comprising:
a comparison section that compares a first rotation position and a second rotation position with each other, the first rotation position being a rotation position of an input shaft of a power transmission mechanism, the second rotation position being a rotation position of an output shaft of the power transmission mechanism; and
a driving force control section that controls driving force of an actuator that drives the input shaft on a basis of a difference between the first rotation position and the second rotation position.

2. The control device according to claim 1, wherein the driving force control section controls the driving force of the actuator on a basis of the difference in a case where external force is applied to the output shaft.

3. The control device according to claim 1, wherein the driving force control section restricts the driving force of the actuator in a case where the difference reaches a predetermined threshold value.

4. The control device according to claim 1, wherein the driving force control section lowers a drive current in the actuator in a case where the difference reaches a predetermined threshold value.

5. The control device according to claim 4, wherein the driving force control section lowers the drive current in the actuator to zero in the case where the difference reaches the predetermined threshold value.

6. The control device according to claim 2, wherein the driving force control section controls the actuator to drive the actuator in a direction in which the external force is received in a case where the difference reaches a predetermined threshold value.

7. The control device according to claim 6, wherein the driving force control section increases a drive current in the actuator to drive the actuator in the direction in which the external force is received in the case where the difference reaches the predetermined threshold value.

8. The control device according to claim 7, wherein the driving force control section increases the drive current in the actuator, and then decreases the drive current in the actuator in accordance with a decrease in the difference.

9. The control device according to claim 1, comprising a determination section that determines an integrated value of a current flowing through the actuator, wherein
the driving force control section restricts the driving force of the actuator when the integrated value reaches a predetermined value.

10. The control device according to claim 1, wherein
the actuator is provided with a first rotation detector that acquires the first rotation position, and
the output shaft of the power transmission mechanism is provided with a second rotation detector that acquires the second rotation position.

11. The control device according to claim 1, wherein
the control device is included in a robotic device that walks autonomously, and
the driving force control section controls the driving force of the actuator included in the robotic device.

12. A control method comprising:
comparing a first rotation position and a second rotation position with each other, the first rotation position being a rotation position of an input shaft of a power transmission mechanism, the second rotation position being a rotation position of an output shaft of the power transmission mechanism; and
controlling driving force of an actuator that drives the input shaft on a basis of a difference between the first rotation position and the second rotation position.

13. A program that causes a computer to function as:
a means for comparing a first rotation position and a second rotation position with each other, the first rotation position being a rotation position of an input shaft of a power transmission mechanism, the second rotation position being a rotation position of an output shaft of the power transmission mechanism; and
a means for controlling driving force of an actuator that drives the input shaft on a basis of a difference between the first rotation position and the second rotation position.
